(19) United States
(12) Patent Application Publication
(10) Pub. No.: US 2011/0035415 A1
(43) Pub. Date: Feb. 10, 2011

(54) Integration of the virtual library system

(76) Inventor: Slavomir RYBAR, Kosice (SK)

Correspondence Address: Ling Wu, 1107 Bettstrail Way, Potomac, MD, 20854, US

(21) Appl. No.: 12/847,417

(22) Filed: Jul. 30, 2010

(30) Foreign Application Priority Data
Aug. 10, 2009 (SK) PUV 87-2009

(51) Int. Cl. G06F 17/30

(52) U.S. Cl. 707/802; 707/E17.044

(57) ABSTRACT

An integration of virtual library system determined especially for storing, exchange and making electronic pedagogical materials accessible composed of minimum one provider block and minimum one access block is provided, and the principle is that at least one provider block is connected to at least one provider login block of the database server being connected through the transmission channel to at least one provider operation block being connected through the transmission channel to at least one personal teacher's module of the virtual library which is connected through the transmission channel to at least one access instructional module of the virtual library and at least one access block is connected through Internet to at least one access login block which is through the transmission channel connected to at least one access instructional module.

### BACKGROUND OF THE INVENTION

The technical solution refers to the integration of the virtual library system determined especially for storing, exchanging and making pedagogical materials available in the instruction process.

Current classical instruction systems for students in schools and educational institutions are based on a teacher-student dialogue in a limited time as the teacher is first obliged to explain new subject-matter to all students en block and has little or no time to devote his/her time to individual students and to explanation of the subject-matter in form of individual dialogues with individuals—this is still a prevailing form of instruction not only at elementary but also at secondary schools.

Up to the present time, integration of multimedia classrooms as are classical computer classrooms with a limited number of computer equipment mostly depending on financial possibilities of the particular institution is known. Costly maintenance of these computer classrooms is a disadvantage as well as purchase of licensed software significantly burdens relatively low school budgets.

Another known technical solution is the instruction system for the study of individual topics by means of Internet, namely by the transformation of the subject-matter to a medium or a subject-matter direct shown on the Internet. A disadvantage of this system is absence of inclusion other teachers or also students by means of Internet.

Another known technical solution is the Dutch universal instruction system for natural sciences, technical subjects and mathematics providing a fast acquisition of experimental data, a simple data handling, especially data storage and transmission, their graphical and tabular display, complex tools for result analysis, tools for simulation of phenomena and input parameters in the modeling environment with graphical output, measurement of point position in various video clip images aimed at independent work of persons interested in the work in physical computer lab in a particular environment. A disadvantage of this system is absence of including other teachers or also students by means of the Internet and its inapplicability for other subjects.

Another known technical solution is described in the Slovak registered utility model UVz No. 2 673 named Instruction Aid Containing Questions and Sample Responses composed of at least one sheet of questions, responses and evaluation template whereas the sheet comprises an area, e.g. a column, for at least one question and areas for at least two sample responses are allocated to it with each sample response having a separate area for marking the selected response, e.g. by a cross, and the edge of the sheet is equipped with the first adjuster and the other one is on the evaluation template and at least one indication of the correct response whereby the evaluation template with the second adjuster is advantageously set up universally and contains indication of correct responses to evaluate at least two, eventually several sheets of questions and responses of the particular test. A disadvantage of this technical solution is its limited use only in testing students' knowledge in writing and impossibility to be used with electronic instruction systems.

Another known solution is described in Czech extinct patent document No. 288 947 with the priority from the Swedish patent application 1996 9602475 called Method and equipment for data processing where data are stored as encrypted values of data elements in records in the first database whereby each value of a data element is connected to the corresponding type of the data element and, in the second database, a catalogue of data element protection is stored containing for each individual type of a data element one or more protection attributes introducing rules of data element value processing being connected to individual types of data elements in the first database , and in each measure retrieved by the user aimed at processing the particular data element in the first database, and the user processing of the particular value is controlled in accordance with the retrieved protection attribute where the equipment for data processing with the first database contains the second database and means adapted in each measure retrieved by the user to process the particular value. A disadvantage of this system is that a communication between individual participants is impossible as all input data are loaded as encrypted ones.

Another technical solution is described in the Czech registered utility model UV No. 12 276 called Integration of Multimedia Classroom Controlled by One Computer determined for teaching audio, video, multimedia computer programs using also Internet where the multimedia work station of the teacher with one computer with controlling software for the interconnection unit is connected to individual pupil or student work stations and is also connected to at least one computer monitor for a pupil or a student for audio reception, and computer monitors connected to the computer of the teacher serve for visual reception. A disadvantage of this system is that it does not allow individual pupils or students as well as the teacher a free choice and access to stored information.

Another known technical solution is described in the Czech registered utility model UV No. 13 888 called Integration of Control, Communication and Instruction System for Computer Classroom where an interface unit controlled by the controlling software from the teacher's computer is connected to the teacher's computer and individual pupil's or student's work stations equipped with earphones with microphone are interconnected through the interface unit. The teacher's work station is also equipped with earphones with microphone and the teacher selects a function on his/her computer by means of the controlling software. The function is transmitted to individual pupil's or student's work station by means of the interface unit and the teacher has the possibility of discreet hearing of one pupil or student, may communicate with one selected pupil or student, may talk to all pupils or students. A disadvantage of this system is that it is not able to store and exchange information between individual pupils or students as well as teachers.

Another known technical solution is described in the Czech registered utility model UV No. 12 183 called Integration of Instruction Computer System where the output of audio data source, output of video data source and output of text data source are parallel-connected to the computer controlling system through data switch of the switching system. The control system is interactively connected to the switching system timer and the data switch which is interactively switched to the output of audio data source, output of video data source and output of text data source. The disadvantage of this system is that it does not allow information storage and exchange between participants.

### SUMMARY OF THE INVENTION

The above mentioned insufficiencies are significantly removed by the integration of virtual library system determined especially for storing, exchange and making electronic pedagogical materials accessible composed of minimum one provider block and minimum one access block in accordance with the technical solution the principle of which is that at least one provider block is connected to at least one provider login block of the database server being connected through the transmission channel to at least one provider operation block being connected through the transmission channel to at least one personal teacher's module of the virtual library which is connected through the transmission channel to at least one access instructional module of the virtual library and at least one access block is connected through Internet to at least one access login block which is through the transmission channel connected to at least one access instructional module.

### BRIEF DESCRIPTION OF THE DRAWINGS

FIG. 1 shows the integration of the virtual library system schematically.

### DETAILED DESCRIPTION OF THE PREFERRED EMBODIMENTS

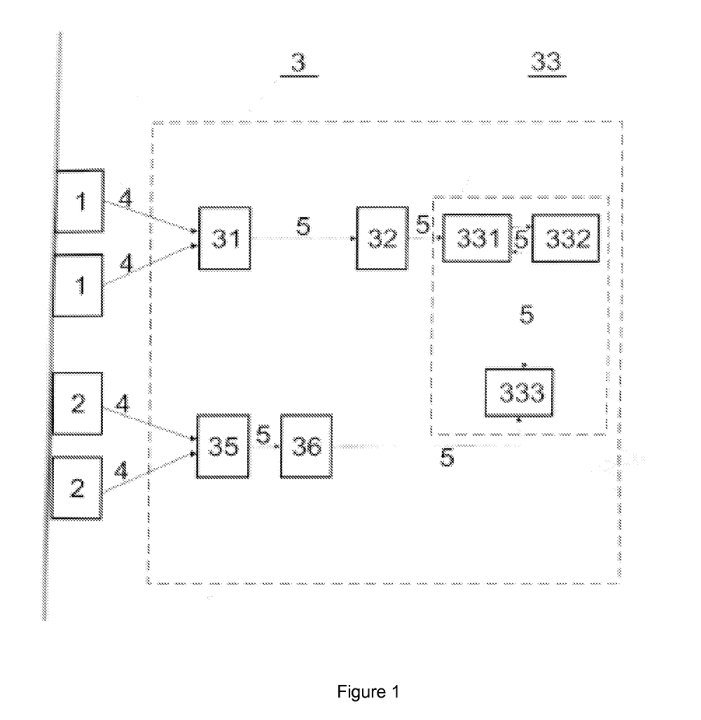

The technical solution will be explained in detail by means of FIG. 1.

### Embodiment 1

Integration of the virtual library system is pursuant to FIG. 1 formed by two provider blocks 1, i.e. personal computers of teachers of the educational institution. The provider blocks 1 are through Internet 4 connected to two provider login blocks 31 of the database server 3 for login of teachers of the educational institution through the login name and password. Provider login blocks 31 are through transmission channel 5 connected to the provider operation block 32 determined for storing, exchange and retrieval of electronic instruction materials in the virtual library 33. The provider retrieval block 32 is though the transmission channel 5 connected to two personal teacher modules 331 determined for storing own electronic instructional materials of teachers of the educational institution. Personal instructional modules 331 are through channel 5 connected to the aggregate teacher module 332 determined for storing and making own as well as adopted electronic instructional materials of teachers of the educational institution accessible between each other. Personal instructional modules 331 and aggregate instructional module 332 are located in the virtual library 33.

### Embodiment 2

Integration of the virtual library system is pursuant to FIG. 1 formed by one provider block 1, i.e. the personal computer of the teacher of the educational institution, and two access blocks 2, i.e. two notebooks of two students of the educational institution. The provider block 1 is through Internet 4 connected to the provider login block 31 of the database server 3 determined for login of the teacher of the educational institution through the login name and password. The provider login block 31 is connected through the transmission channel 5 to the provider operation block 32 determined for storing, exchange and retrieval of electronic instructional materials in the virtual library 33. The provider operation block 32 is connected through the transmission channel 5 to one personal teacher module 331 determined for storing own electronic instructional materials of the teacher of the educational institution. The personal instructional module 331 is through the transmission channel 5 connected to the aggregate instructional module 332 determined for storing and making own as well as adopted electronic instructional materials of teachers of the educational institution accessible. The aggregate instructional material 332 is connected through the transmission channel 5 to two access instructional modules 333 determined for making own as well as adopted electronic instructional materials for students of the educational institution accessible. The personal instructional module 331, the aggregate instructional module 332 and two access instructional modules 333 are located in the virtual library 33. Two access blocks 2 are through Internet 4 connected to two provider login blocks 35 of the database server 3 determined for login of students through the login name and password. Two access login blocks 35 are through the transmission channel 5 connected to the access retrieval block 36 determined for retrieval of electronic instructional materials in the virtual library 33. The access retrieval block 36 is through the transmission channel 5 connected to two access instructional modules 333 determined for making own as well as adopted electronic instructional materials accessible for students of the educational institution.

The integration pursuant to the technical solution may be used for development of education of pupils and students of educational institutions, especially in nurseries, at elementary and secondary schools, grammar schools, special and art schools. In the virtual library, there are multiple types of electronic materials, it means any materials in electronic form that are or may be used for instructional purposes. These especially are learning materials and presentations, job sheets, exercises, assignments, tests, written works, audio records, visual records, audio-visual records, Internet sites, methodological materials and other materials that are or may be used in the preparation, implementation and evaluation of the pedagogical process. These materials may have multiple forms, namely figures, diagrams, photos, animations, interactive works created in one of instructional programs, links to Internet sites and other forms.

The invention claimed is:

1. Integration of the virtual library system determined for storing, exchange and making electronic pedagogical materials formed by at least one provider block and at least one access block both being characterized by the fact that at least one provider block (1) is connected through Internet (4) to at least one provider access block (31) of the database server (3) that is through transmission channel (5) connected to at least one provider operation block (32) that is through transmission channel (5) connected to at least one personal pedagogical module (331) of the virtual library (33) that is through one transmission channel (5) connected to the aggregate pedagogical module (332) of the virtual library (33) that is through transmission channel (5) connected to at least one access instructional module (333) of the virtual library (33) and at least one access block (2) is through Internet (4) connected to at least one access login block (35) that is through transmission channel (5) connected to at least one access retrieval block (36) that is through transmission channel (5) connected to at least one access instructional module (333).
